(19) United States
(12) Patent Application Publication
(10) Pub. No.: US 2001/0034803 A1
(43) Pub. Date: Oct. 25, 2001

(54) Connecting a hand-held device to peripheral devices

(75) Inventors: Noam Sorek, Zichron Yaacov (IL); Ron Fridental, Herzliya (IL); Ilia Vitsnudel, Even Yehuda (IL)

Correspondence Address: Ladas & Parry, 26 West 61St Street, New York, NY, 10023, US

(73) Assignee: ALST TECHNICAL EXCELLENCE CENTER

(21) Appl. No.: 09/780,937

(22) Filed: Feb. 9, 2001

Related U.S. Application Data
(60) Provisional application No. 60/181,432, filed on Feb. 10, 2000.

(51) Int. Cl. G06F 13/00; G06F 13/38

(52) U.S. Cl. 710/129

(57) ABSTRACT

A peripheral module for a hand-held computing device having a device electrical port at a device surface thereof. The module includes a first electrical port receiver at a first surface of the module, configured to mate with the device electrical port of the hand-held computing device, and a first peripheral electrical port, of substantially identical shape and electrical functionality to the device electrical port, at a second surface of the module, opposite the first surface. The first peripheral electrical port is available to mate with a further peripheral module having a second electrical port receiver that is also configured to mate with the device electrical port of the hand-held computing device. Circuitry, coupled between the first electrical port receiver and the first peripheral electrical port, is adapted to carry out an application function in association with the computing device while the first electrical port receiver is mated with the device electrical port of the computing device.

### CROSS-REFERENCE TO RELATED APPLICATION

This application claims the benefit of U.S. Provisional Patent Application No. 60/181,432, filed Feb. 10, 2000, which is incorporated herein by reference.

### FIELD OF THE INVENTION

The present invention relates generally to hand-held computing devices and peripheral devices, and specifically to methods and apparatus for communicating therebetween.

### BACKGROUND OF THE INVENTION

Methods and systems are known in the art for connecting hand-held computing devices, such as Palm Pilot™ (3Com, Santa Clara, Calif.) and Visor™ (Handspring, Inc., Mountain View, Calif.), to one or more peripheral devices thereof, with the option of connecting these thereafter to a computer. Most of these hand-held devices have a connecting port, which enables them to connect with a peripheral device or optionally to a host computer through a wired connection, such as through an adapter or a cradle.

Examples of peripheral devices which connect to the base of a hand-held device such as a Palm Pilot include a Palm™m100 HotSync® Cradle, a Palm™ portable keyboard, a NorthStar Mobile MemorySafe, a PalmConnect® USB kit and a Palm™ m100 HotSync® cable. A cradle differs from other peripheral devices in that it typically functions as a physical support of the hand-held device, with a wired connection to a computer.

One of the major drawbacks of hand-held devices, as opposed to larger computers, is that once a hand-held device has been connected to a peripheral device, no other peripheral device can typically be connected to the hand-held device without first removing the first peripheral device. Although it is possible for the hand-held device to access peripherals through a host computer, using a cradle wired to the host, for example, this procedure may be lengthy and constrains the portability of the hand-held device, which is one of its major advantages. The practical and ergonomic design of connectivity of peripheral and hand-held devices is currently poor. Many of the peripheral devices are tailor-made to suit one specific model of a hand-held device, and are thus unsuitable for many other hand-held devices. There is therefore a need for improvement in the interconnectivity of hand-held devices and peripherals.

### SUMMARY OF THE INVENTION

It is an object of some aspects of the present invention to provide improved apparatus and methods for enabling physical and electrical connection of peripheral devices with a hand-held device.

In preferred embodiments of the present invention, a hand-held device is connected to one or more peripheral devices so as to enable the hand-held device and the peripheral devices to communicate simultaneously. This is typically effected by chaining the hand-held device and the plurality of the peripheral devices in series. More preferably this is performed by interconnecting a plurality of the peripheral devices sequentially in a stack, each of the devices having one port for connecting with the hand-held device itself or with the preceding peripheral device in the chain, and a second port for connecting with the next peripheral device or with a cradle. Any suitable type of port may be used for this purpose, but preferably, the ports comprise electrical connectors and have mechanical “footprints” that are compatible with the existing connectors and footprints of the hand-held device and of its cradle. Thus, the peripheral devices may be connected in a stack between the hand-held device and the cradle in substantially any desired combination and order.

Preferably, electrical signals are passed through the peripheral devices to the hand-held device and from the hand-held device through the peripheral devices. Each peripheral device is configured to intercept and process the signals that are directed to it, while passing all other signals onward up or down the chain. This chaining is preferably supported not only at the physical level, but also by communications and application software running on the peripheral devices. Thus, the hand-held device and all of the peripheral devices may be operated simultaneously. The hand-held device can communicate with any of the peripheral devices, as well as with a host computer when connected through the peripheral devices to the cradle. Most preferably, the peripheral devices are also able to communicate with the host through the cradle.

In an additional preferred embodiment of the present invention, batteries of at least one of the peripheral devices and of the hand-held device are charged through the cradle during the simultaneous operation of these devices. Moreover, the system and method described hereinbelow enable the simultaneous provision of power, suited to each of the hand-held device and the peripheral devices. This is preferably performed by dividing a time duration of the supplying of power into parts so as to provide each device with the power supply for at least one part of the time duration. Alternatively or additionally, some or all of the peripheral devices, which are not equipped with their own batteries, may receive power from the battery of the hand-held device.

In the context of the present patent application and in the claims, the term “hand-held” device refers to any and all portable electronic devices that have suitable computing power and are designed to be operated while held in one hand. Although preferred embodiments are described herein mainly with reference to “palmtop” computers, as mentioned in the Background of the Invention, the principles of the present invention are similarly applicable to hand-held devices of other types, such as cellular telephones.

There is therefore provided, in accordance with a preferred embodiment of the present invention, a method of communication with a hand-held computing device having a device electrical port at a device surface thereof, the method including:

providing a first peripheral module having a first electrical port receiver at a first surface thereof, configured to mate with the device electrical port of the hand-held computing device, and a first peripheral electrical port, of substantially identical shape and electrical functionality to the device electrical port, at a second surface thereof, opposite the first surface;

coupling the first peripheral module to the computing device by bringing the first surface of the module into proximity with the device surface of the computing device and connecting the electrical port receiver of the peripheral module to the device electrical port, so that the first peripheral electrical port at the second surface of the first peripheral module is available for communication with a second peripheral module having a second electrical port receiver that is also configured to mate with the device electrical port of the hand-held computing device; and

conveying electrical signals between the hand-held computing device and the first peripheral module through the connected port receiver and electrical port.

Preferably, coupling the first peripheral module to the computing device includes fixing the computing device to the first peripheral module such that the first surface of the module contacts the device surface.

In a preferred embodiment, the method includes inserting the first peripheral module into a cradle that is adapted to receive the computing device, while the first peripheral module is coupled to the computing device. Preferably, conveying the electrical signals includes conveying the signals through the cradle between a computer and at least one of the first peripheral module and the hand-held computer device.

Preferably, the method includes providing the second peripheral module having the second electrical port receiver, and coupling the second peripheral module to first peripheral module by connecting the second electrical port receiver of the second peripheral module to the first peripheral electrical port of the first module, wherein conveying the electrical signals includes conveying the signals between the hand-held computing device and the second peripheral module through the first peripheral module. Further preferably, coupling the second peripheral module to first peripheral module includes stacking together the computing device, the first peripheral module and the second peripheral module. Additionally or alternatively, the second peripheral module has a second peripheral electrical port, of substantially identical shape and electrical functionality to the device electrical port, in a position on the second peripheral module that is opposite the second electrical port receiver, so that the second peripheral electrical port is available for communication with a third peripheral module having a third electrical port receiver that is also configured to mate with the device electrical port of the hand-held computing device.

In a preferred embodiment, conveying the electrical signals includes charging a battery of the hand-held device through the first peripheral electrical port while the first peripheral module is coupled to the computing device. Additionally or alternatively, conveying the electrical signals includes providing electrical power to the peripheral module from a battery in the hand-held computing device.

Preferably, conveying the electrical signals includes conveying data regarding an application of the peripheral module between the module and the computing device.

There is also provided, in accordance with a preferred embodiment of the present invention, a peripheral module for a hand-held computing device having a device electrical port at a device surface thereof, including:

a first electrical port receiver at a first surface of the module, configured to mate with the device electrical port of the hand-held computing device;

a first peripheral electrical port, of substantially identical shape and electrical functionality to the device electrical port, at a second surface of the module, opposite the first surface, which first peripheral electrical port is available to mate with a further peripheral module having a second electrical port receiver that is also configured to mate with the device electrical port of the hand-held computing device; and

circuitry, coupled between the first electrical port receiver and the first peripheral electrical port, which is adapted to carry out an application function in association with the computing device while the first electrical port receiver is mated with the device electrical port of the computing device.

Preferably, the first surface of the module is shaped so as to fixedly contact the device surface of the computing device when the first electrical port receiver mates with the device electrical port, while the second surface of the module is shaped in a manner substantially similar to the device surface of the computing device, so as to fixedly contact the further peripheral module.

Preferably, the first peripheral electrical port is adapted to be received by a cradle that is designed to receive the computing device.

Further preferably, when the first peripheral electrical port mates with the second electrical port receiver of the further peripheral module while the first electrical port receiver mates with the device electrical port of the computing device, the circuitry is operative to convey electrical signals between the further peripheral module and the hand-held computing device. Most preferably, the peripheral modules are shaped and configured so as to be stacked together in communication with the computing device.

In a preferred embodiment, the module includes a battery, which provides power to at least the circuitry in the peripheral module, and the circuitry includes a battery-charging circuit. Alternatively, the circuitry is coupled by the first electrical port receiver to draw power from a battery in the computing device.

There is additionally provided, in accordance with a preferred embodiment of the present invention, computing apparatus, including:

a hand-held computing device having a device electrical port at a device surface thereof; and

a first peripheral module, which includes:

a first electrical port receiver at a first surface of the module, configured to mate with the device electrical port of the hand-held computing device;

a first peripheral electrical port, of substantially identical shape and electrical functionality to the device electrical port, at a second surface of the module, opposite the first surface, which first peripheral electrical port is available to mate with a second peripheral module having a second electrical port receiver that is also configured to mate with the device electrical port of the hand-held computing device; and

circuitry, coupled between the first electrical port receiver and the first peripheral electrical port, which is adapted to carry out an application function in association with the computing device while the first electrical port receiver is mated with the device electrical port of the computing device.

In a preferred embodiment, the computing device includes a palmtop computer. In another preferred embodiment, the computing device includes a cellular telephone.

The present invention will be more fully understood from the following detailed description of the preferred embodiments thereof, taken together with the drawings, in which:

### BRIEF DESCRIPTION OF THE DRAWINGS

FIG. 1 is a simplified pictorial illustration showing a system for connecting a hand-held device with a plurality of peripheral devices, in accordance with a preferred embodiment of the present invention; and

FIG. 2 is a simplified block diagram showing details of intercommunication between the hand-held device and the plurality of peripheral devices of FIG. 1, in accordance with a preferred embodiment of the present invention.

### DETAILED DESCRIPTION OF PREFERRED EMBODIMENTS

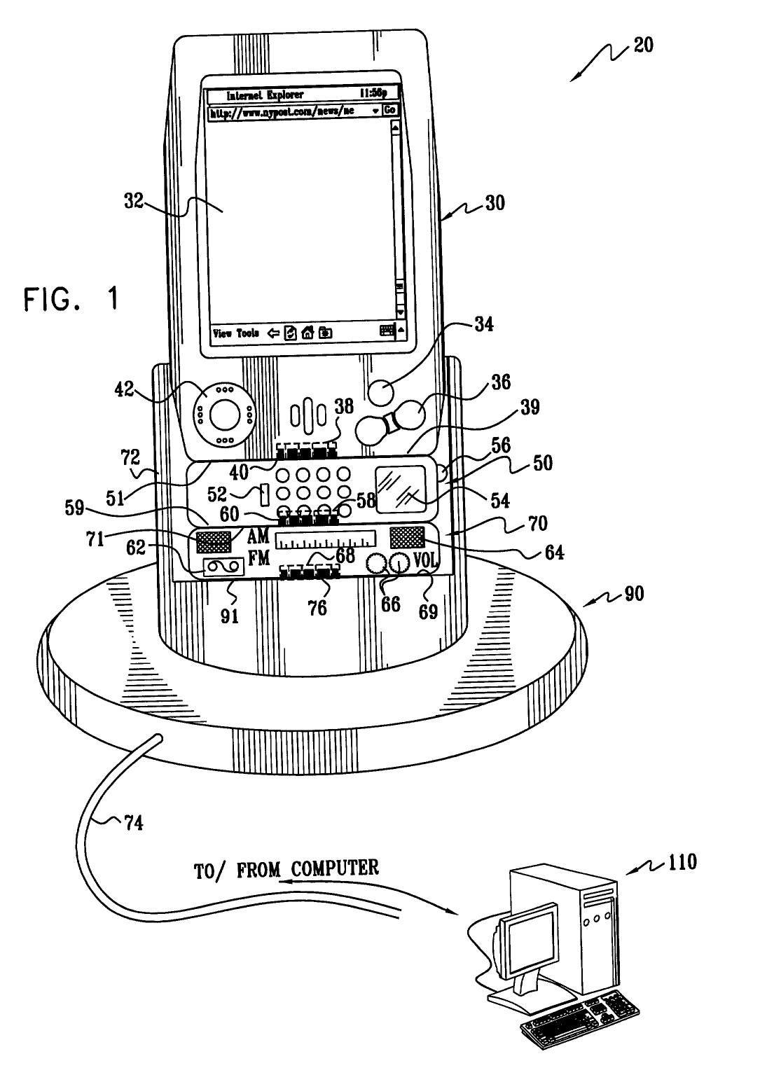

FIG. 1 is a simplified pictorial illustration illustrating a system 20 for connecting a hand-held device 30 with a plurality of peripheral devices, such as devices 50 and 70, in accordance with a preferred embodiment of the present invention. Hand-held device 30 preferably comprises a palmtop computer, such as the above-mentioned Palm Pilot or Visor device. Typically, hand-held device 30 comprises an electrical port 38 configured to connect to either an electrical port receiver 40 on a peripheral device 70 or to an electrical port receiver 76 on a device cradle 90. This port enables the hand-held device to communicate with both a plurality of peripheral devices 50, 70, and with device cradle 90.

Hand-held device 30 also typically comprises a display 32, a plurality of control elements 34, 36, and 42, and other features known in the art. A lower surface 39, defining a footprint of device 30, houses port 38.

Peripheral device 50 comprises an electrical port 58 at one of its ends, so as to communicate with an electrical port receiver of another peripheral device, such as a port receiver 60 of device 70. Port 58 is located on device 50 at the opposite side from electrical port receiver 40. Preferably, port receiver 40 is adapted to receive an electrical port identical to port 58, such as port 38 of hand-held device 30 or a port 68 of another peripheral device, such as device 70. These features enable each peripheral device, such as devices 50 and 70, to act as a link in a chain of peripheral devices, and to communicate with hand-held device 30 and with device cradle 90. Device 50 is further constructed with a surface 51 which is designed to receive a) the footprint of lower surface 39 of device 30, with port 38 connecting to port receiver 40, and b) a footprint of a lower surface 69 of device 70, with port 68 connecting to a port receiver 76 on cradle 90. In hand-held device systems known in the art, port receiver 76 connects with port 38, without intervening peripheral devices. In system 20, device 30 can preferably be inserted into cradle 90 in this manner, as well, when peripheral devices 50 and 70 are removed.

A wide variety of peripheral devices may be used in the context of the present invention. In the example shown in FIG. 1, device 50 comprises a cellular phone module, having features such as control elements 52, a display 54, and an antenna 56, in addition to port receiver 40 and port 58. As another example, device 70 comprises a radio-cassette recorder, comprising a recording element 62, a microphone 64 and a plurality of control elements 66. Additionally or alternatively, system 20 may comprise a number of other peripheral devices stacked below the hand-held device. These peripheral devices may include, but are not limited to, a modem, an electronic camera, a modular memory, a Geographic Positioning System (GPS) device, a non-volatile memory, such as a writable minidisk, a speaker, a microphone, an MP3 player, a bar code reader, or a business card reader.

Devices 30, 50, 70 can be stacked in cradle 90, which typically provides some physical support for at least peripheral device 70 proximal thereto. Cradle 90 generally comprises a physical stand 72, a wired connection 74, and electrical port receiver 76, which can receive any of ports 68 or 58 of the peripheral devices or port 38 of hand-held device 30. Cradle 90 communicates via wired connection 74 with a computer 110, and/or with a power supply.

As noted above, hand-held device 30 and peripheral devices 50 and 70 have respective lower surfaces 39, 59 and 69 with substantially similar footprints, each comprising respective electrical port 38, 58, or 68. Cradle 90 and peripheral devices 70 and 50 comprise respective structural surfaces 91, 71, and 51 having port receivers 76, 60 and 40 respectively, such that the surfaces at least partially match the contour of the footprints of surfaces 39, 59 and 69. Thus, any of devices 70, 50 and 30 may be physically mounted on cradle 90, and the positions of any of peripheral devices 70 and 50 may be interchanged. Hand-held device 30 may be mounted on any of the peripheral devices or directly on the cradle.

Optionally, peripheral devices 50 and 70 and hand-held device 30 communicate with computer 110 simultaneously through cradle 90.

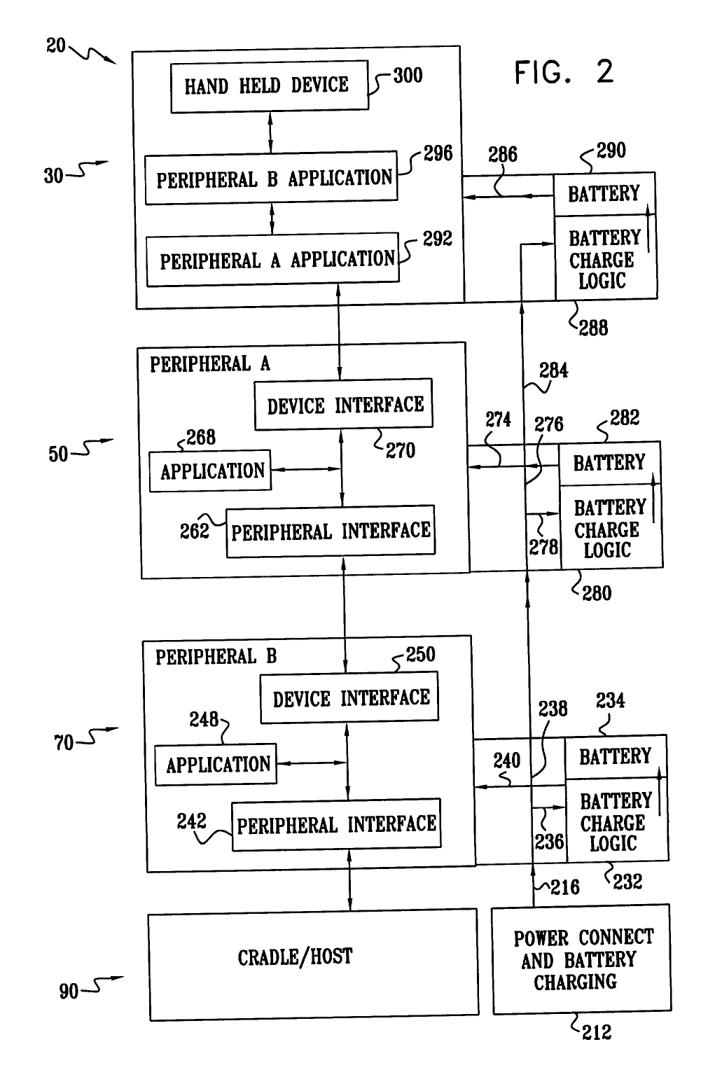

FIG. 2 is a simplified block diagram showing functional details of system 20, in accordance with a preferred embodiment of the present invention. Cradle 90 comprises a power connection and battery charging element 212, which communicates through an electrical connection 216 with peripheral device 70 (designated peripheral B), which in turn connects through an electrical connection 238 to peripheral device 50 (designated peripheral A), which in turn connects to hand-held device 30 via an electrical connection 284. Connections 216, 238 and 284 pass through the ports and port receivers shown in FIG. 1.

Devices 70, 50 and 30 are shown as having respective batteries 234, 282 and 290 and battery charge logic 232, 280 and 288. Power is communicated from element 212 to the battery charge logic along electrical connections 216, 238, 276 and 284. Batteries 234, 282, and 290 respectively provide power to devices 70, 50, and 30 through respective electrical connections 240, 274 and 286.

System 20 is constructed so as to enable the simultaneous provision of power to each of the hand-held device and the plurality of peripheral devices. This may optionally be performed by dividing a time duration for providing the power supply into parts so as to provide each device 30, 50, and 70 with the power supply for at least one part of the time duration. This may be performed by pulsing each device for part of the time so as to convey electricity along a respective battery connection 284, 278, and 236 so as to charge at least one respective battery 234, 282, and 290. Alternatively, all of the batteries may be charged in parallel simultaneously. Devices 70, 50 and 30 may further alternatively be activated by power from element 212, or may have no battery of their own and depend for power on the one of the other devices to which they are connected. Element 212 or the battery charge logic may temporarily stop the transfer of power if all devices have fully charged batteries, and require no more power from element 212. Batteries 234, 282, and 290 respectively provide power to devices 70, 50, and 30 through respective electrical connections 240, 274 and 286.

Although devices 30, 50 and 70 are shown in the figures as being lodged in cradle 90, the devices may also remain connected together and operate in cooperation apart from the cradle. In this case, the power for the devices is provided solely by batteries 234, 282 and 290, but in other respects, the operation of the devices is essentially unchanged.

FIG. 2 also illustrates schematically electronic communication, such as transfer of software commands and data between cradle 90 and peripheral devices 50 and 70 and hand-held device 30. Each peripheral device 50 and 70 comprises a respective device interface 270, 250, through which it communicates with hand-held device 30, and a peripheral interface 262, 242, through which it communicates with cradle 90 and through the cradle with host 110. Each of the peripheral devices also comprises an application software kernel 248, 268, for carrying out the basic application functions for which it is designed. In addition, hand-held device 30 comprises its own operating system 300 and application interfaces 292 and 296 for interacting with the applications of the peripheral devices.

The device and peripheral interfaces of devices 50 and 70 are arranged in a daisy chain, in terms of both the electrical connections and the communication protocols between them. Thus, any communication from host 110 via cradle 90 that is not directed specifically to device 70 is passed on to the next device 50, and so on, until it is captured by the device to which it is directed. Correspondingly, each of the devices responds to communication from device 30 above it, and transmits any communication not directed to it down to the next device or to host 110. Thus, there is two-way communication up and down the stack or chain of devices 30, 50 and 70 to and from the host.

Daisy chaining also takes place at the application level. Thus, for example, when the hand-held device sends an application command down the chain, it may be addressed to either or both of application kernels 268 and 248. The appropriate kernel or kernels receive and process the command via the device and peripheral interfaces. For example, the hand-held device may control both cellular phone device 50 and recording device 70 in this manner simultaneously. Similarly, data sent up the chain to the hand-held device from one of the peripheral devices is first examined by application interface 292, which either processes the data itself if appropriate, or passes it on to application interface 296 and from there to operating system 300 as required.

Hand-held device 30 may thus be used to send an electronic signal via any of the plurality of peripheral devices 50, 70. For example, it may send an electronic mail message via telephone 50. The message is sent from operating system 300 via application interface 292 to application kernel 268, which then sends the message employing techniques known in the art of cellular telephony.

Preferably, hand-held device 30 and intervening peripheral devices (such as device 50) are capable of operating in the manner described above even when the last device in the chain (such as peripheral device 70) is not designed to support chaining of peripherals in this manner. This will be the case, for example, when device 70 is a legacy device, which was designed to mate with hand-held device 30 without intervening peripherals. In this situation, the hand-held and peripheral devices will still be electrically compatible with one another and with cradle 90, but hand-held device 30 and peripheral device 50 will need to adjust their communication and application protocols to accommodate the protocols that are supported by device 70. Preferably, hand-held device 30 and peripheral devices 50 are programmed to recognize automatically that the last device in the chain (device 70) does not support the daisy-chaining protocol and to adjust their communications with device 70 accordingly. Hand-held device 30 will also operate in this manner when it is connected directly to device 70. Other possible combinations of devices operating in accordance with embodiments of the present invention together with legacy devices will be apparent to those skilled in the art.

Although the preferred embodiment shown in FIGS. 1 and 2 includes two peripheral devices of certain particular types, it will be understood that larger or smaller numbers of peripheral devices may be used in this configuration. It will thus be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A method of communication with a hand-held computing device having a device electrical port at a device surface thereof, the method comprising:
providing a first peripheral module having a first electrical port receiver at a first surface thereof, configured to mate with the device electrical port of the hand-held computing device, and a first peripheral electrical port, of substantially identical shape and electrical functionality to the device electrical port, at a second surface thereof, opposite the first surface;
coupling the first peripheral module to the computing device by bringing the first surface of the module into proximity with the device surface of the computing device and connecting the electrical port receiver of the peripheral module to the device electrical port, so that the first peripheral electrical port at the second surface of the first peripheral module is available for communication with a second peripheral module having a second electrical port receiver that is also configured to mate with the device electrical port of the hand-held computing device; and
conveying electrical signals between the hand-held computing device and the first peripheral module through the connected port receiver and electrical port.

2. A method according to claim 1, wherein coupling the first peripheral module to the computing device comprises fixing the computing device to the first peripheral module such that the first surface of the module contacts the device surface.

3. A method according to claim 1, and comprising inserting the first peripheral module into a cradle that is adapted to receive the computing device, while the first peripheral module is coupled to the computing device.

4. A method according to claim 3, wherein conveying the electrical signals comprises conveying the signals through the cradle between a computer and at least one of the first peripheral module and the hand-held computer device.

5. A method according to claim 1, and comprising:
providing the second peripheral module having the second electrical port receiver; and
coupling the second peripheral module to first peripheral module by connecting the second electrical port receiver of the second peripheral module to the first peripheral electrical port of the first module,
wherein conveying the electrical signals comprises conveying the signals between the hand-held computing device and the second peripheral module through the first peripheral module.

6. A method according to claim 5, wherein coupling the second peripheral module to first peripheral module comprises stacking together the computing device, the first peripheral module and the second peripheral module.

7. A method according to claim 5, wherein the second peripheral module has a second peripheral electrical port, of substantially identical shape and electrical functionality to the device electrical port, in a position on the second peripheral module that is opposite the second electrical port receiver, so that the second peripheral electrical port is available for communication with a third peripheral module having a third electrical port receiver that is also configured to mate with the device electrical port of the hand-held computing device.

8. A method according to claim 1, wherein conveying the electrical signals comprises charging a battery of the hand-held device through the first peripheral electrical port while the first peripheral module is coupled to the computing device.

9. A method according to claim 1, wherein conveying the electrical signals comprises providing electrical power to the peripheral module from a battery in the hand-held computing device.

10. A method according to claim 1, wherein conveying the electrical signals comprises conveying data regarding an application of the peripheral module between the module and the computing device.

11. A peripheral module for a hand-held computing device having a device electrical port at a device surface thereof, comprising:
a first electrical port receiver at a first surface of the module, configured to mate with the device electrical port of the hand-held computing device;
a first peripheral electrical port, of substantially identical shape and electrical functionality to the device electrical port, at a second surface of the module, opposite the first surface, which first peripheral electrical port is available to mate with a further peripheral module having a second electrical port receiver that is also configured to mate with the device electrical port of the hand-held computing device; and
circuitry, coupled between the first electrical port receiver and the first peripheral electrical port, which is adapted to carry out an application function in association with the computing device while the first electrical port receiver is mated with the device electrical port of the computing device.

12. A module according to claim 11, wherein the first surface of the module is shaped so as to fixedly contact the device surface of the computing device when the first electrical port receiver mates with the device electrical port.

13. A module according to claim 12, wherein the second surface of the module is shaped in a manner substantially similar to the device surface of the computing device, so as to fixedly contact the further peripheral module.

14. A module according to claim 11, wherein the first peripheral electrical port is adapted to be received by a cradle that is designed to receive the computing device.

15. A module according to claim 14, wherein when the first peripheral electrical port is received by the cradle while the first electrical port receiver mates with the device electrical port of the computing device, the circuitry is operative to pass electrical signals through the cradle between a computer and at least one of the first peripheral module and the hand-held computing device.

16. A module according to claim 11, wherein when the first peripheral electrical port mates with the second electrical port receiver of the further peripheral module while the first electrical port receiver mates with the device electrical port of the computing device, the circuitry is operative to convey electrical signals between the further peripheral module and the hand-held computing device.

17. A module according to claim 16, wherein the peripheral modules are shaped and configured so as to be stacked together in communication with the computing device.

18. A module according to claim 11, and comprising a battery, which provides power to at least the circuitry in the peripheral module.

19. A module according to claim 18, wherein the circuitry comprises a battery-charging circuit.

20. A module according to claim 11, wherein the circuitry is coupled by the first electrical port receiver to draw power from a battery in the computing device.

21. Computing apparatus, comprising:
a hand-held computing device having a device electrical port at a device surface thereof; and
a first peripheral module, which comprises:
a first electrical port receiver at a first surface of the module, configured to mate with the device electrical port of the hand-held computing device;
a first peripheral electrical port, of substantially identical shape and electrical functionality to the device electrical port, at a second surface of the module, opposite the first surface, which first peripheral electrical port is available to mate with a second peripheral module having a second electrical port receiver that is also configured to mate with the device electrical port of the hand-held computing device; and
circuitry, coupled between the first electrical port receiver and the first peripheral electrical port, which is adapted to carry out an application function in association with the computing device while the first electrical port receiver is mated with the device electrical port of the computing device.

22. Apparatus according to claim 21, wherein the first surface of the module is shaped so as to fixedly contact the device surface of the computing device when the first electrical port receiver mates with the device electrical port.

23. Apparatus according to claim 22, wherein the second surface of the module is shaped in a manner substantially similar to the device surface of the computing device, so as to fixedly contact the second peripheral module.

24. Apparatus according to claim 21, and comprising a cradle, which is adapted to receive individually both the computing device and the first peripheral module, and which comprises a cradle electrical port receiver, which is adapted to mate individually with both the device electrical port and the first peripheral electrical port.

25. Apparatus according to claim 24, wherein when the first peripheral module is received by the cradle while the first electrical port receiver mates with the device electrical port of the computing device, the circuitry is operative to pass electrical signals through the cradle between a computer and at least one of the first peripheral module and the hand-held computing device.

26. Apparatus according to claim 21, wherein when the first peripheral electrical port mates with the second electrical port receiver of the second peripheral module while the first electrical port receiver mates with the device electrical port of the computing device, the circuitry is operative to convey electrical signals between the second peripheral module and the hand-held computing device.

27. Apparatus according to claim 26, wherein the peripheral modules are shaped and configured so as to be stacked together in communication with the computing device.

28. Apparatus according to claim 21, wherein the first peripheral module comprises a battery, which provides power to at least the circuitry in the peripheral module.

29. Apparatus according to claim 28, wherein the circuitry comprises a battery-charging circuit.

30. Apparatus according to claim 21, wherein the computing device comprises a battery, and wherein the circuitry is coupled by the first electrical port receiver to draw power from the battery in the computing device.

31. Apparatus according to claim 21, wherein the computing device comprises a palmtop computer.

32. Apparatus according to claim 21, wherein the computing device comprises a cellular telephone.
